(19) United States
(12) Patent Application Publication
(10) Pub. No.: US 2023/0274251 A1
(43) Pub. Date: Aug. 31, 2023

(54) PRODUCT TRANSACTION INFORMATION DISPLAY METHOD AND TRANSACTION PRIVACY PROTECTION SYSTEM BASED ON SMART ACCESSORY

(71) Applicant: SHENZHEN CHUANGLIANG TECHNOLOGY DEVELOPMENT CO., LTD., Shenzhen (CN)

(72) Inventor: Chunyan FU, Shenzhen (CN)

(73) Assignee: SHENZHEN CHUANGLIANG TECHNOLOGY DEVELOPMENT CO., LTD., Shenzhen (CN)

(21) Appl. No.: 18/143,620

(22) Filed: May 5, 2023

Related U.S. Application Data
(63) Continuation-in-part of application No. PCT/CN2020/136640, filed on Dec. 16, 2020.

(30) Foreign Application Priority Data
Nov. 6, 2020 (CN) 202011229969.8

(51) Int. Cl. G06Q 20/32; G06Q 20/38; G06Q 20/40

(52) U.S. Cl. CPC G06Q 20/322; G06Q 20/38215; G06Q 20/3823; G06Q 20/3829; G06Q 20/389; G06Q 20/4014

(57) ABSTRACT

A product transaction information display method and a transaction privacy protection system based on a smart accessory include connecting the smart accessory to obtain a display of transaction information and one-click sending transaction instructions to complete the transaction. The smart accessory stores a user key and personal privacy information, and the encrypted user key and personal privacy information in the smart accessory worn by the user are read to realize a decentralized electronic identity or a decentralized identity (DID) method.

### CROSS-REFERENCE TO THE RELATED APPLICATION

This application is a continuation-in-parts (CIP) application of International Application No. PCT/CN2020/136640 filed on Dec. 16, 2020, which claims priority to Chinese Patent Application No. 202011229969.8, filed on Nov. 6, 2020, the entire contents of which are incorporated herein by reference.

### TECHNICAL FIELD

This application relates to a product transaction information display method and a transaction privacy protection system based on a smart accessory, a computer device, and a storage medium.

### BACKGROUND

With the development of the Internet of Things technology and chip technology, types and forms of smart wearable devices have been diversified and smart accessories combined with highly-integrated chips have emerged. Product transaction information display and the personal privacy data protection technology in the transaction system have also been developed in conjunction with the definition of decentralized personal digital identity. Thereby bringing convenience to information display and transaction and resolving the problem of personal privacy data security. Traditionally, people need to actively search for related product information through a search engine or an online mall, resulting in a lack of convenience and efficiency in obtaining smart accessory product information. In addition, current personal account information is stored on an online mall platform, and personal privacy data is prone to be leaked and stolen. Online mall accounts on different platforms are not shared and therefore a plurality of sets of personal privacy data are simultaneously stored on a plurality of online mall platforms; further aggravating the risk of personal privacy data leakage.

### SUMMARY

According to the embodiments disclosed in this application, a product transaction information display method and a transaction privacy protection system based on a smart accessory, a computer device, and a storage medium are provided.

A product transaction information display method based on smart accessory is provided, including:

when there is a need to connect to the smart accessory or obtain product information, accessing a home page of a client, where the home page includes a product information display region and a connection region for connecting to the smart accessory;

displaying at least one item of product information through the product information display region, where the product information includes smart accessory product information;

accessing an information page corresponding to the product information when a trigger instruction corresponding to the product information is obtained through the product information display region; and

when a connection instruction corresponding to a to-be-connected smart accessory is obtained through the connection region, establishing a communication connection between the client and the to-be-connected smart accessory according to the connection instruction.

A transaction privacy protection system based on a smart accessory is provided, including a terminal, the smart accessory, and a server, where

When there is a need to connect to the smart accessory or obtain product information, the terminal accesses a home page of a client, where the home page includes a product information display region and a connection region for connecting to the smart accessory;

the terminal pulls product information at the server, and displays at least one item of product information through the product information display region, where the product information includes smart accessory product information;

the terminal accesses an information page corresponding to the product information when obtaining a trigger instruction corresponding to the product information through the product information display region; and

when obtaining a connection instruction corresponding to a to-be-connected smart accessory through the connection region, the terminal establishes a communication connection between the client and the to-be-connected smart accessory according to the connection instruction.

A computer device is provided, including a memory and one or more processors, where computer-readable instructions are stored in the memory, and when the computer-readable instructions are executed by the processor, the one or more processors perform the following steps:

when there is a need to connect to a smart accessory or obtain product information, accessing a home page of a client, where the home page includes a product information display region and a connection region for connecting to the smart accessory;

displaying at least one item of product information through the product information display region, where the product information includes smart accessory product information;

accessing an information page corresponding to the product information when a trigger instruction corresponding to the product information is obtained through the product information display region; and

when a connection instruction corresponding to a to-be-connected smart accessory is obtained through the connection region, establishing a communication connection between the client and the to-be-connected smart accessory according to the connection instruction.

One or more non-volatile computer-readable storage media storing computer-readable instructions are provided, where when the computer-readable instructions are executed by one or more processors, the one or more processors perform the following steps:

When there is a need to connect to a smart accessory or obtain product information, accessing a home page of a client, where the home page includes a product information display region and a connection region for connecting to the smart accessory;

displaying at least one item of product information through the product information display region, where the product information includes smart accessory product information;

accessing an information page corresponding to the product information when a trigger instruction corresponding to the product information is obtained through the product information display region; and

when a connection instruction corresponding to a to-be-connected smart accessory is obtained through the connection region, establishing a communication connection between the client and the to-be-connected smart accessory according to the connection instruction.

Details of one or more embodiments of this application are presented in the accompanying drawings and descriptions below. Other features and advantages of this application will become apparent from the specification, accompanying drawings, and claims.

### BRIEF DESCRIPTION OF THE DRAWINGS

To describe the technical solutions in the embodiments of this application more clearly, the following briefly describes the accompanying drawings required for the embodiments. Apparently, the accompanying drawings in the following description show merely some embodiments of this application, and a person of ordinary skill in the art may derive other drawings from these accompanying drawings without creative efforts.

FIG. 1 is an application scenario diagram of a product transaction information display method based on a smart accessory according to one or more embodiments.

FIG. 2 is a schematic flowchart of a product transaction information display method based on a smart accessory according to one or more embodiments.

FIG. 3 is a schematic diagram when a client is connected to a smart accessory according to one or more embodiments.

FIG. 4 is a schematic flowchart of a product transaction information display method based on a smart accessory according to another embodiment.

FIG. 5 is a block diagram of a transaction privacy protection system based on a smart accessory according to one or more embodiments.

FIG. 6 is a block diagram of a computer device according to one or more embodiments.

### DETAILED DESCRIPTION OF THE EMBODIMENTS

To make the technical solutions and advantages of this application clearer and more comprehensible, the following further describes this application in detail with reference to the accompanying drawings and embodiments. It should be understood that the specific embodiments described herein are merely used to explain this application but are not intended to limit this application.

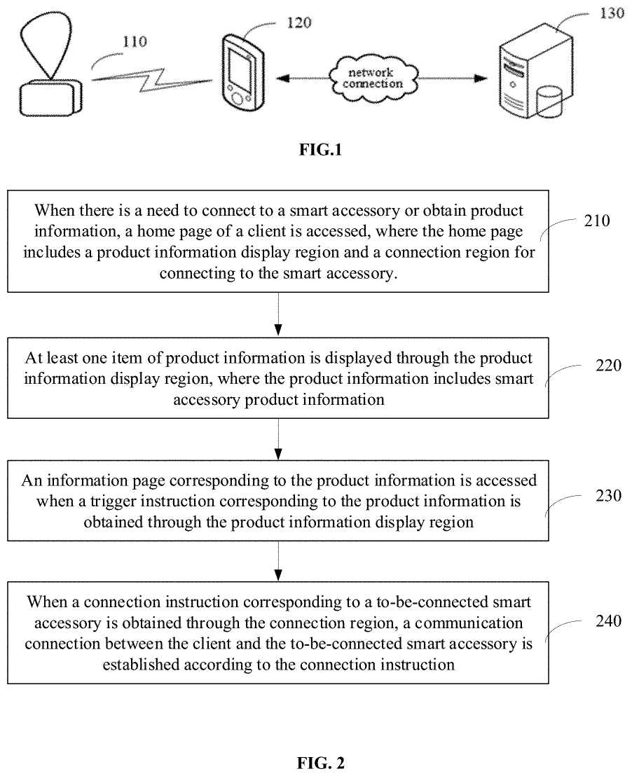

A product transaction information display method based on a smart accessory provided in this application may be applied to an application environment shown in FIG. 1. The smart accessory 110 communicates with a terminal 120, and the terminal 120 communicates with a server 130. The smart accessory 110 may be, but is not limited to, a smart bracelet, a smart necklace, a smart ring, smart earrings, a smart brooch, or the like. For the convenience of operation, the smart accessory 110 is preferably a smart accessory worn by an individual. The terminal 120 may be, but is not limited to, a variety of personal computers, laptops, smartphones, tablets, and portable wearable devices, and the server 130 may be implemented as a separate server or a server cluster composed of a plurality of servers.

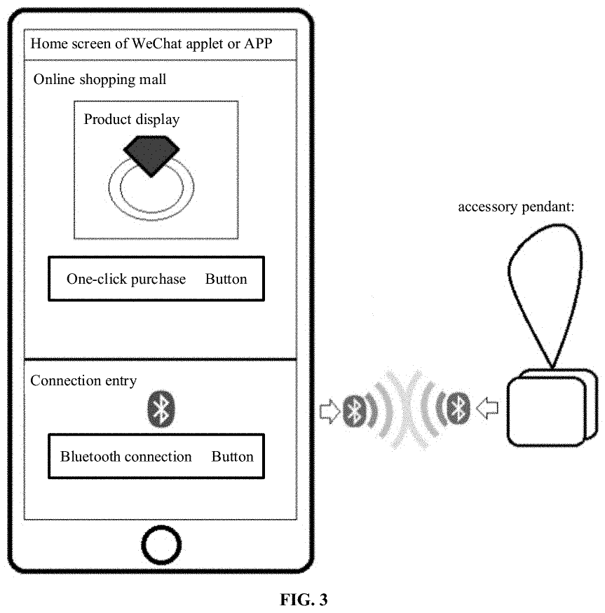

In an embodiment, as shown in FIG. 2, a product transaction information display method based on a smart accessory is provided, and the method is applied to the terminal in FIG. 1. The smart accessory in this embodiment is smart accessory worn by an individual, and the method includes the following steps:

Step 210: When there is a need to connect to a smart accessory or obtain product information, a home page of a client is accessed, where the home page includes a product information display region and a connection region for connecting to the smart accessory.

Step 220: At least one item of product information is displayed through the product information display region, where the product information includes smart accessory product information;

Step 230: An information page corresponding to the product information is accessed when a trigger instruction corresponding to the product information is obtained through the product information display region.

Step 240: When a connection instruction corresponding to a to-be-connected smart accessory is obtained through the connection region, a communication connection between the client and the to-be-connected smart accessory is established according to the connection instruction.

The client is installed on the terminal, and the client may be an independent application program or a subroutine running on a parent program. For example, the parent program is WeChat and the subroutine is an applet running on WeChat. When an instruction for starting the client by a user is received, the home page of the client is accessed. The home page includes at least two regions such as the connection region and the product information display region. One or a plurality of communication connection modes for the communication connection to the smart accessory may be displayed in the connection region. “A plurality of” means two or more. Each communication connection mode has a corresponding connection button. When one connection button in the connection is triggered, the client generates a corresponding connection instruction, and establishes the communication connection to the to-be-connected smart accessory according to the connection instruction. At least one item of product information related to the smart accessory may be displayed in the product information display region. Smart accessory product information may also be referred to as smart accessory information. Product information may be divided into different information types according to content of the product information. For example, an information type corresponding to smart accessory introduction information is smart accessory information, an information type corresponding to product brand information is brand information, and an information type corresponding to product store information is store information.

Products include smart accessory and a smart accessory merchandise product. For example, the smart accessory merchandise product may be a smart accessory charging box or smart accessories. The smart accessory is embedded with a micro-smart wearable module, and the micro-smart wearable module includes a plurality of modules, such as a main control module, a communications module, an encryption processing module, and a storage module. The main control module includes a controller, and the controller may implement a corresponding control function through a specialized chip of the smart accessory. The communications module may be a Bluetooth communications module, a Wi-Fi communications module, or an NFC communications module, and is configured to establish the communication connection to the client. The storage module may be a non-volatile storage medium and is configured to store a control program delivered by the client, user information, and key information. The encryption processing module is configured to encrypt information data written into the storage module. Preferably, the encryption module encrypts user information and key information. The micro-smart wearable module may be the micro-smart wearable LED module disclosed in the patent CN210157438U, or another smart module with a similar function.

The smart accessory may establish the communication connection to the client in at least one manner. The communication connection includes a Bluetooth connection, a wireless network connection, an NFC connection, and the like. The connection instruction for establishing communication with the to-be-connected smart accessory may be sent by the to-be-connected smart accessory to the client. For example, the main control module of the to-be-connected smart accessory may send the connection instruction to the client. Alternatively, the connection instruction may be sent by the client to the to-be-connected smart accessory. For example, the client scans a two-dimensional code on the to-be-connected smart accessory and sends the connection instruction to the main control module of the to-be-connected smart accessory.

When the client is started, the client sends a pull request of smart information to a server, and the server returns corresponding product information according to the pull request. The server may obtain the corresponding product information through analysis in a plurality of manners. The product information may be obtained through big data analysis, such as the most popular smart accessory or other products in the latest period, or may be determined according to an advertisement push parameter, or may be obtained through user preference analysis. In one of the embodiments, the communication connection between the client and the to-be-connected smart accessory may be a Bluetooth connection, and a schematic diagram when the client and the to-be-connected smart accessory (such as a smart pendant) are connected is shown in FIG. 3.

When a product is a smart accessory, big data analysis may be performed. The server may fetch smart accessory information related to the smart accessory from a plurality of websites according to a fixed frequency, where the smart accessory information includes a smart accessory style, smart accessory sales, a smart information brand, and the like; and perform big data analysis by using the fetched information. The server may further update the smart accessory information after the big data analysis, to obtain the most popular smart accessory in the latest period in time. When the advertisement push parameter is used for analysis, the server obtains current effective advertisement information of the smart accessory, analyzes the push parameter according to a preset push rule, and determines to-be-pushed smart accessory information.

When a product is a smart accessory, user preference analysis may be adopted. The client may obtain, according to a corresponding unique identifier in a smart accessory chip, all smart accessory information of the user and information of a page on which the user browses the smart accessory, and analyze user's preferences to obtain smart accessory information corresponding to the user's preferences.

When a product is a smart accessory, further, in one of the embodiments, the server records the user as an active user based on the pull request of the smart information, and the server collects statistics on the number of active users within a preset period. The server collects statistics on smart accessory information browsed by each user and records a behavior characteristic of the user. The behavioral characteristic includes clicking on content of the page by the user, such as clicking on a picture, enlarging a picture, and inquiring a price. The user's preferences are analyzed according to the behavioral characteristic of the user, so as to push smart accessory information closer to personal preferences.

If a product is a smart accessory, smart accessory information may be displayed in the product information display region in a circular scrolling manner, or smart accessory information may be displayed in a fixed region manner. In the circular scrolling manner, a plurality of pieces of smart accessory information may be played through circular scrolling. In the fixed manner, only one item of current smart accessory information may be displayed in the product information display region. When the client detects a sliding operation performed by the user on the product information display region, a next item of smart accessory information may be obtained for display.

When a product is smart accessory, a plurality of pieces of accessory information displayed in a circular scrolling manner or a fixed manner may belong to a same information type or different information types. When the user clicks on one item of accessory information, a trigger instruction corresponding to the accessory information is generated, and the client accesses a corresponding information page according to the trigger instruction. A plurality of types of information of the smart accessory may be displayed on the information page, for example, detailed information and purchase information.

It can be understood that when the user is not wearing a smart accessory, the communication connection mode may still be displayed in the connection region. Smart accessory information may also be displayed in the information product information display region in the foregoing manner.

According to the foregoing product transaction information display method based on a smart accessory, when a user needs to connect to the smart accessory or obtain product information, the user may access a home page of a client, where a product information display region and a connection region for connecting to the smart accessory are displayed on the home page, and at least one item of product information may be displayed in the product information display region. The product information includes smart accessory product information. An information page corresponding to the product information is accessed when a trigger instruction corresponding to the product information is obtained through the product information display region, such that the corresponding product information can be quickly displayed to the user. When a to-be-connected smart accessory needs to be connected, a corresponding connection instruction is obtained through the connection region, and a communication connection between the client and the to-be-connected smart accessory is quickly established according to the connection instruction. In the whole process, the user does not need to actively perform a search operation. The home page of the client is accessed, such that the user can easily learn about product information related to a smart accessory product in time through the product information display region.

In an embodiment, the establishing a communication connection between the client and the to-be-connected smart accessory according to the connection instruction includes: reading a user identity corresponding to the to-be-connected smart accessory according to the connection instruction; and when the user identity is verified, establishing the communication connection between the client and the to-be-connected smart accessory; and the method further includes: generating a product information obtaining request according to the user identity, and sending the product information obtaining request to a server through the client, such that the server returns personalized product information to the client.

When the user needs to connect to an existing smart accessory (which may also be referred to as the to-be-connected smart accessory), one of the communication connection modes in the connection region may be trigged to generate the connection instruction between the client and the to-be-connected smart accessory. The client parses the connection instruction and obtains the user identity corresponding to the to-be-connected smart accessory. The user identity is a unique identifier of the smart accessory. Each user identity corresponds to one piece of unique smart accessories. The user identity may be a specific number generated by metadata or key information of the user. The user identity may be prestored in a storage medium of the to-be-connected smart accessory. The client verifies the user identity obtained through parsing, and establishes the communication connection between the client and the to-be-connected smart accessory after the verification succeeds. The client generates the product information obtaining request based on the user identity and sends the product information obtaining request to the server. The server obtains the personalized product information that conforms to the user's preferences according to the user identity. The personalized product information includes personalized smart accessory information, and may be obtained through user preference analysis in the manner in the foregoing embodiment.

The server returns the personalized product information to the client. The client displays the personalized product information in the product information display region on the home page. A display manner may be the same as that in the foregoing embodiment. Because the user identity is in a one-to-one correspondence with the smart accessory, through the verification on the user identity, malicious connection and intrusion can be prevented, and a secure communication connection between the client and the smart accessory is established. In addition, the personalized product information that is closer to the smart accessory or the user's preferences can be obtained.

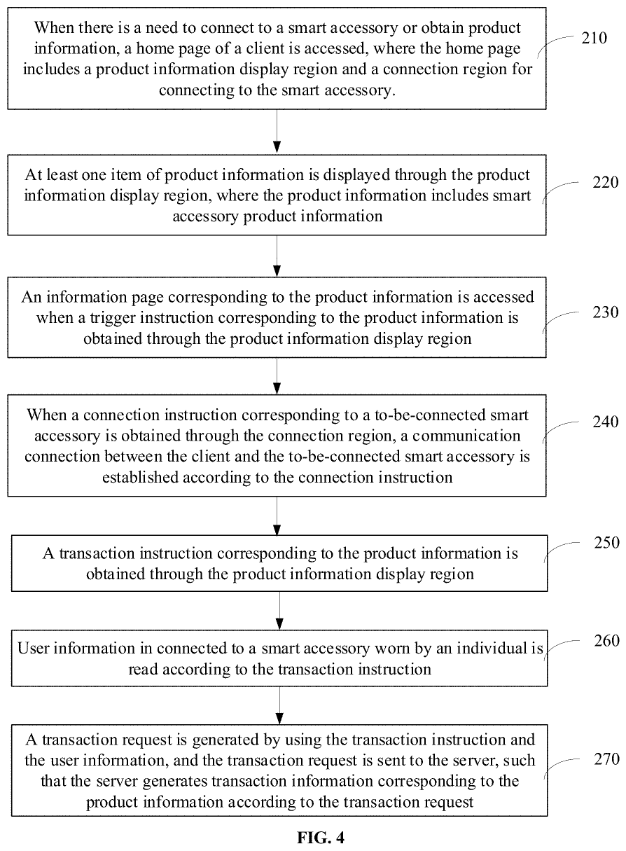

As shown in FIG. 4, in an embodiment, after step 240, the product transaction information display method based on a smart accessory further includes:

Step 250: A transaction instruction corresponding to the product information is obtained through the product information display region.

Step 260: User information in connected to a smart accessory worn by an individual is read according to the transaction instruction.

Step 270: A transaction request is generated by using the transaction instruction and the user information, and the transaction request is sent to the server, such that the server generates transaction information corresponding to the product information according to the transaction request.

In addition to the product information, a transaction button and the like may be displayed in the product information display region. When the user triggers the transaction button for the product information currently displayed in the product information display region, the client generates the transaction instruction corresponding to the product information. The client reads the user information in a storage module of the connected smart accessory according to the transaction instruction. The user information may also be referred to as personal privacy data of the user. The user information (that is, the personal privacy data) includes communication information, key information, access address, connection data, and the like of the user. The communication information may be a mailing address and contact information of a product purchased by the user. The key information includes information such as a key for a digital currency transaction. The key may be generated through encryption by using metadata and block data. The key information may be used to reconfirm an identity of the user. The access address includes an access address of an information page of the smart accessory, for example, the access address of the information page may be an access address of an online mall. The connection data includes connection data with the client and connection data with the information page, such as connection data with the online mall.

The user information stored in the smart accessory (that is, the personal privacy data) is stored in a preset data format. The preset data format includes metadata and block data. The metadata is a smallest data unit for transmission between the smart accessory and the client. The metadata includes a plurality of bytes, for example, the metadata is 20 bytes. The block data is a data set composed of a preset amount of metadata, for example, a data set composed of 32K pieces of metadata.

The metadata includes data content and definition information. The data content includes specific data information, including but not limited to communication information, key information, an access address, connection data, and the like. The definition information includes metadata control information, a data encryption definition, a personal privacy data definition, and the like. Byte content of the metadata control information is obtained by combining the data encryption definition with the personal privacy data definition.

For example, the metadata is 20 bytes, where bytes 0 to 15 are the data content, and bytes 16 to 19 are the definition information of the metadata, bytes 16 and 17 are the metadata control information, a byte 18 is the data encryption definition, and a byte 19 is the personal privacy data definition. Content of the bytes 16 and 17 is defined by a combination of the bytes 18 and 19. For example, the byte 19 is 0x01, the byte 18 is 0xFF, and the bytes 16 and 17 are check values of CRC16 of data content of the bytes 0 to 15. If the byte 19 is 0xFF and the byte 18 is arbitrary content, it indicates that the metadata is a first piece of data in consecutive data, content of the bytes 16 and 17 is length information of the consecutive data, and the consecutive data is used to store information that a single piece of metadata is insufficient to store.

The data encryption definition is an encryption definition of the data content of metadata. There are a plurality of encryption modes, for example, 0x00 is AES encryption, 0x01 is dictionary encryption, 0x02 is DES encryption, 0x03 is RC4 encryption, 0xFF is no encryption. There may be 256 data encryption definition manners. In addition to the encryption definition of common convention in this application, other encryption definitions that are not agreed upon may also be customized by the developer to improve scalability of data encryption.

Different personal privacy data definitions correspond to different data content. For example, if the personal privacy data definition is 0x00, it indicates that the metadata is a key. If the personal privacy data definition is 0xFF, it indicates that the metadata is a first piece of defined data, and block data length information is placed in the metadata control information (for example, bytes 16 and 17). If the personal privacy data definition is 0x01, it indicates that the metadata is contact information of the user such as a phone number. If the personal privacy data definition is 0x02 to 0x12, it indicates that the metadata is a mailing address. If the personal privacy data definition is 0x20 to 0x30, it indicates that the metadata is an Internet access address of an information page of the smart accessory. In addition to the personal privacy data definition of common convention in this application, other definitions that are not agreed upon may also be customized by the developer to improve scalability of data encryption.

Taking 20 bytes of metadata as an example, a corresponding data format is shown in Table 1 below:

TABLE 1

| Personal | Data | | | | | | | | | | | | | | | | | | |
|---|---|---|---|---|---|---|---|---|---|---|---|---|---|---|---|---|---|---|---|
| privacy data | encryption | | | | | | | | | | | | | | | | | | |
| definition | definition | Control | | | | | | | | | | | | | | | | | |
| 0x00-0xFF | 0x00-0xFF | information | | Data content | | | | | | | | | | | | | | | |
| 19 | 18 | 17 | 16 | 15 | 14 | 13 | 12 | 11 | 10 | 9 | 8 | 7 | 6 | 5 | 4 | 3 | 2 | 1 | 0 |

Taking each block data with 64K bytes (32K pieces of metadata) as an example, a data format of the block data is shown in Table 2 below:

TABLE 2

| | Personal | | | | | | | | | | | | | | | | | | | |
|---|---|---|---|---|---|---|---|---|---|---|---|---|---|---|---|---|---|---|---|---|
| | privacy | Data | | | | | | | | | | | | | | | | | | |
| | data | encryption | | | | | | | | | | | | | | | | | | |
| | definition | definition | Control | | | | | | | | | | | | | | | | | |
| | 0x00-0xFF | 0x00-0xFF | information | | Data content | | | | | | | | | | | | | | | |
| Offset | 19 | 18 | 17 | 16 | 15 | 14 | 13 | 12 | 11 | 10 | 9 | 8 | 7 | 6 | 5 | 4 | 3 | 2 | 1 | 0 |
| address | | | | | | | | | | | | | | | | | | | | |
| 0x0000 | 0x01 | 0xFF (no | CRC16 | | | | | | | | | | | | | | | | | |
| | | encryption) | | | | | | | | | | | | | | | | | | |
| . . . | | | | | | | | | | | | | | | | | | | | |
| 0x000F | 0x00 | 0x00 | CRC16 | | | | | | | | | | | | | | | | | |
| | | (data | | | | | | | | | | | | | | | | | | |
| | | content of | | | | | | | | | | | | | | | | | | |
| | | AES | | | | | | | | | | | | | | | | | | |
| | | encryption) | | | | | | | | | | | | | | | | | | |
| . . . | | | | | | | | | | | | | | | | | | | | |

| | | | |
|---|---|---|---|
| 0x7FFF | 0x00 | 0xFF | length |

The metadata is a smallest data unit for communication between the client and the smart accessory. The client reads the metadata and identifies an encryption mode of a data encryption definition, a personal privacy data definition, and data content according to the data format of the metadata.

When the client generates the transaction instruction, if the user information is prestored in the storage medium of the smart accessory, the client reads the block data in the storage medium of the smart accessory, identifies each piece of metadata according to the offset address in the block data, identifies a corresponding decoding mode and data content according to the data structure of the metadata, and decodes the data content according to the decoding mode. The encoding mode is defined in the data structure of the metadata, and the client obtains the corresponding decoding mode according to the defined encoding mode. The client extracts the corresponding user information from decoded data content according to the personal privacy data definition in the metadata. For example, if the metadata is 20 bytes, the client identifies the personal privacy data definition in a byte 19, reads the data encryption and decryption mode in a byte 18, and identifies the data content in bytes 0 to 15. The client decrypts the data content according to the encryption and decryption mode and obtains the corresponding user information.

The client reads the communication information in the user information, generates the transaction request by using the communication information and the transaction instruction, and sends the transaction request to the server. It can be understood that if the user information is not prestored in the connected smart accessory, the user information is extracted from the transaction information generated by the client and the connected smart accessory, and the user information is written into the storage medium of the connected smart accessory for storage.

In this embodiment, the transaction button in the product information display region of the home page is trigged, and the corresponding transaction request can be generated according to the currently displayed product information, such that when browsing smart accessory information, users can easily and quickly buy products they are interested in. When an online transaction is performed, the user information is stored in the smart accessory as personal privacy data, and the user information is defined in a format of metadata and block data, such that the personal privacy data of user can be effectively protected from being disclosed. When an online transaction needs to be performed, the client reads the personal privacy data in the connected smart accessory. Because the personal privacy data of the user is not stored in the server, but is stored in the smart accessory of the user, security of the personal privacy data of the user can be greatly improved.

Further, according to the above personal privacy data definition, the client can identify information such as a communication address and a contact number in the user information in the decrypted data. The client enters the identified information such as the communication address and the contact number into an order page to generate order information. The client generates the transaction request by using the order information and the transaction instruction, and sends the transaction request to the server. In this way, when the user wants to perform an online transaction of the smart accessory, the order information can be generated automatically and the transaction request can be initiated, to provide convenience for customers.

In addition, in order to effectively improve security of the transaction, the client may further enter the extracted communication information into the order page to generate the order information, and then generate the transaction request by using the order information, the key information and the transaction instruction, and send the transaction request to the server. The key information is decrypted in the foregoing manner and may be used as a unique identifier of the smart accessory to confirm the identity of the user. The server may further use the key information and client information for authentication, for example, the client information may be a verification code, and the authentication can be successful only when both the key information and the verification code are verified. Therefore, security of online transaction of products can be further improved. After the authentication succeeds, the server may return corresponding payment information to the client. The payment information may be a payment page, and the payment page includes a payment amount and a payment password entry region, and payment can be completed after a payment password is entered. In addition, the key information may be a key for digital currency payment. The server may automatically perform digital currency payment according to the key information, and return the corresponding payment information to the client after the payment is completed. The payment information includes a paid amount and the like. Automatic payment can be completed by using the key information, thereby facilitating a smart accessory transaction by the user.

Further, the key information of the user may also be read separately by the terminal in a non-transaction state, and is used in other transaction scenarios of digital currency.

In an embodiment, the connection region on the home page of the client includes at least one connection button, and after the user identity is verified, the method further includes: when one connection button is triggered, generating a corresponding connection instruction, and establishing the communication connection to the smart accessory according to the connection instruction; displaying a plurality of control buttons in the connection region after the communication connection is established; and when one of the control buttons is triggered, generating a control setting instruction for the connected smart accessory, and accessing a corresponding control page according to the control setting instruction.

One or a plurality of connection buttons may be included in the connection region on the home page of the client. “A plurality of” means two or more. The connection buttons include a Bluetooth connection button, a Wi-Fi connection button, and the like. When the user triggers one connection button in the connection region, the corresponding connection instruction is generated. The client establishes a communication connection to a communications module of the to-be-connected smart accessory according to the connection instruction. The client may prompt that the corresponding communication connection succeeds. For example, in the connection region, it shows that a Bluetooth connection succeeds. Further, after the communication connection is established, the connected smart accessory may also issue a corresponding prompt. For example, the connected smart accessory may issue a sound prompt, or the connected smart accessory may issue a prompt by using an LED light.

After establishing the communication connection, the client displays the plurality of control buttons in the connection region on the home page. By triggering the control button, the user may use the client to control the connected smart accessory. When one of the control buttons is triggered, the control setting instruction for the connected smart accessory is generated, and the corresponding control page is accessed according to the control setting instruction. Specifically, the control button includes a light sensing control button, a sound control button, a clock control button, and the like. When the user triggers one of the control buttons, the control setting instruction for the connected smart accessory is generated, and the corresponding control page is accessed. In the control page, the user can conveniently adjust a function of the connected smart accessory according to the user's personal preferences.

It should be understood that although the steps in the flowcharts of FIG. 2 and FIG. 4 are shown in turn according to instructions of arrows, these steps are not necessarily performed in the order indicated by the arrows. Unless clearly stated in this specification, there is no strict order restriction on execution of these steps, and these steps may be performed in another order. Moreover, at least some of the steps in FIG. 2 and FIG. 4 may include a plurality of sub-steps or a plurality of phases. These sub-steps or phases are not necessarily completed at a same moment, but may be performed at different moments, and these sub-steps or phases are not necessarily performed sequentially in turn, but may be performed alternately or interchangeably with other steps or at least parts of sub-steps or phases of other steps.

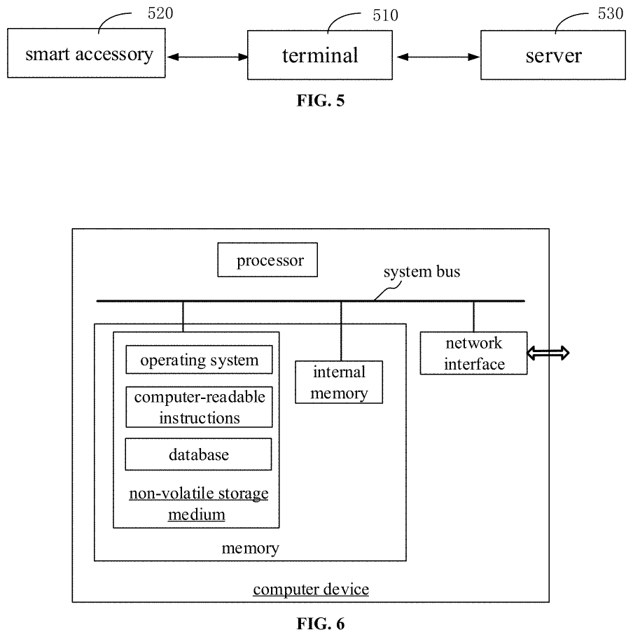

In an embodiment, as shown in FIG. 5, a transaction privacy protection system based on a smart accessory is provided, including terminal 510, smart accessory 520, and server 530.

When there is a need to connect to the smart accessory or obtain product information, the terminal 510 accesses a home page of a client, where the home page includes a product information display region and a connection region for connecting to the smart accessory 520; and the terminal 510 pulls product information at the server 530, and displays at least one item of product information through the product information display region, where the product information includes smart accessory product information.

The terminal 510 accesses an information page corresponding to the product information when obtaining a trigger instruction corresponding to the product information through the product information display region.

The terminal 510 accesses an information page corresponding to the product information when obtaining a trigger instruction corresponding to the product information through the product information display region.

When the existing smart accessory 520 needs to be connected, the terminal obtains a connection instruction corresponding to the smart accessory 520 through the connection region, and establishes a communication connection between the client and the to-be-connected smart accessory 520 according to the connection instruction.

For specific restrictions of the transaction privacy protection system based on a smart accessory, refer to the above restrictions on the product transaction information display method based on the smart accessory. Details are not described herein again. The transaction privacy protection system based on the smart accessory may be implemented in whole or in part by software, hardware and a combination thereof.

In an embodiment, the terminal 510 reads a user identity corresponding to the smart accessory 520 according to the connection instruction; and when the user identity is verified, establishes the communication connection between the client and the to-be-connected smart accessory 520. The terminal 510 generates a product information obtaining request according to the user identity, and sends the product information obtaining request to the server 530 through the client, such that the server 530 returns personalized product information to the client.

In an embodiment, the terminal 510 obtains a transaction instruction corresponding to the product information through the product information display region, and reads user information in the connected smart accessory 520 according to the transaction instruction; and the terminal 510 generates a transaction request by using the transaction instruction and the user information, and sends the transaction request to the server 530, such that the server 530 generates transaction information corresponding to the product information according to the transaction request.

In an embodiment, the terminal 510 reads, according to the transaction instruction, block data in the connected smart accessory worn by an individual; identifies each piece of metadata in the block data, and obtains a corresponding personal privacy data definition, an encoding and decoding mode, and data content according to a data structure of the metadata; and decodes the data content according to the encoding and decoding mode, and extracts the corresponding user information from decoded data content according to the personal privacy data definition.

In an embodiment, the user information includes communication information and key information, and the terminal 510 further enters the extracted communication information into an order page accordingly to generate order information; and generates a transaction request by using the order information, the key information, and the transaction instruction, and sends the transaction request to the server 530.

In an embodiment, after the server 530 completes authentication on the transaction request according to the key information, payment information is returned to the terminal 510.

In an embodiment, the connection region on the home page of the client includes at least one connection button, and when one connection button is triggered, the terminal 510 further generates a corresponding connection instruction, and establishes the communication connection to the connected smart accessory 520 according to the connection instruction; displays a plurality of control buttons in the connection region after establishing the communication connection; and when one of the control buttons is triggered, generates a control setting instruction for the connected smart accessory, and accesses a corresponding control page according to the control setting instruction.

In an embodiment, unlike storing a distributed personal digital identity DID (Decentralized Identity) in a form of a block chain, personal privacy data may be stored in a smart accessory memory rather than in a network or in a server of some enterprises. For example, a unique user information identifier may be stored in each piece of smart accessory, and the user information identifier may correspond to a user identifier (DID Identifier) and a DID user document (DID document) of the distributed personal digital identity DID. In addition, a private key of the DID block chain may also be stored in the smart accessory memory. When a network server needs personal privacy data for identity verification and authentication, the terminal 510 may read directly the data from the smart accessory memory. Because the smart accessory is worn by the user, the personal privacy data in the smart accessory memory is also kept by the individual, thereby completely controlling the personal privacy information by the individual and implementing a decentralized personal privacy data management mode.

In an embodiment, when the user uses network application software through the terminal, if user identity verification and/or authentication are/is required, after receiving a DID identity information request returned by the server, the terminal reads the personal privacy data stored in the smart accessory, such as a user identifier and a DID user document, encrypts the personal privacy data by using a private key, and then sends the encrypted personal privacy data to the server. Alternatively, the terminal communicates with the smart accessory after receiving the DID identity information request returned by the server. The smart accessory encrypts the personal privacy data by using the private key, and then sends the encrypted personal privacy data to the server. After receiving the personal privacy data from the terminal or the smart accessory, the server decrypts the personal privacy data by using a public key to obtain relevant personal login data, and completes login after the user identity verification and/or authentication succeed/succeeds.

When a product is a smart accessory, each piece smart accessory has a unique user identifier and a DID identity. Token airdropping or issuing may be performed on a block chain program in the server, and an airdropped token voucher is stored directly in the memory of the smart accessory. For example, the block chain program in the serve may be issued or airdropped into the smart accessory through NFT, and an airdropped NFT voucher is directly stored in the memory of the smart accessory.

In one embodiment, an individual smart accessory may be used a hardware wallet for block chain tokens or a DID hardware wallet through software system settings. Because the hardware wallet for the smart accessory can communicate with the terminal through a wireless protocol, and the terminal is connected to the server through a network, the block chain program in the server may be issued through the network or tokens are airdropped to the terminal. Then the terminal communicates with the smart accessory through the wireless protocol, and the airdropped or issued tokens may be stored in a storage chip of the smart accessory.

In an embodiment, a computer device is provided. The computer device may be a terminal, and an internal structure diagram may be shown in FIG. 6. The computer device includes a processor, a memory, and a network interface connected through a system bus. The processor of the computer device is configured to provide computing and control capabilities. The memory of the computer device includes a non-volatile storage medium and an internal memory. The non-volatile storage medium stores an operating system, computer-readable instructions, and a database. The internal memory provides an environment for running of the operating system and the computer-readable instructions in the non-volatile storage medium. The network interface of the computer device is configured to communicate with an external terminal through a network connection. The computer-readable instructions are executed by the processor to implement a product transaction information display method based on a smart accessory.

A person skilled in the art can understand that the structure shown in FIG. 6 is only a block diagram of a part of the structure related to the solutions in this application and does not constitute a limitation to the computer device to which the solutions in this application are application. Specifically, the computer device may include more or fewer components than shown in the figure, or combine some components, or have different component arrangements.

A person of ordinary skill in the art may understand that all or some of the processes of the methods in the foregoing embodiments may be implemented by computer-readable instructions instructing relevant hardware. The computer-readable instructions may be stored in a non-volatile computer-readable storage medium, and when being executed, the computer-readable instructions may implement the processes the above method embodiments. Any reference to the memory, storage, database or other media used in the embodiments provided in this application may include a non-volatile and/or volatile memory. The non-volatile memory may include a read-only memory (ROM), a programmable ROM (PROM), an electrically programmable ROM (EPROM), an electrically erasable programmable ROM (EEPROM), or a flash memory (FLASH). The volatile memory may include a random access memory (RAM) or an external cache memory. For illustration rather than limitation, the RAM is in a variety of forms, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a Rambus (Rambus) direct RAM (RDRAM), a direct Rambus dynamic RAM (DRDRAM), and a Rambus dynamic RAM (RDRAM).

The technical features in the foregoing embodiments may be randomly combined. To make the description brief, all possible combinations of the technical features in the foregoing embodiments are not described. However, as long as there is no contradiction between a combination of the technical features, the combination shall fall within the scope of this specification. The foregoing embodiments merely describe several implementations of this application, and description of the implementations is relatively specific and detailed, but shall not be understood as a limitation on the scope of this application. It should be noted that a person of ordinary skill in the art may make several variations and improvements without departing from the idea of this application and the variations and improvements shall fall within the protection scope of this application. Therefore, the protection scope of this application shall be subject to the protection scope of the claims.

What is claimed is:

1. A product transaction information display method based on a smart accessory, comprising:
when there is a need to connect to the smart accessory or obtain product information, accessing a home page of a client, wherein the home page comprises a product information display region and a connection region for connecting to the smart accessory;
displaying at least one item of product information through the product information display region, wherein the product information comprises smart accessory product information;
accessing an information page corresponding to the product information when a trigger instruction corresponding to the product information is obtained through the product information display region; and
when a connection instruction corresponding to a to-be-connected smart accessory is obtained through the connection region, establishing a communication connection between the client and the to-be-connected smart accessory according to the connection instruction.

2. The product transaction information display method according to claim 1, wherein the establishing of the communication connection between the client and the to-be-connected smart accessory according to the connection instruction comprises:
reading a user identity corresponding to the to-be-connected smart accessory according to the connection instruction;
when the user identity is verified, establishing the communication connection between the client and the to-be-connected smart accessory; and
generating a product information obtaining request according to the user identity, and sending the product information obtaining request to a server through the client, such that the server returns personalized product information to the client.

3. The product transaction information display method according to claim 1, further comprises:
obtaining a transaction instruction corresponding to the product information through the product information display region;
reading user information in the connected smart accessory according to the transaction instruction, wherein the smart accessory is a smart accessory worn by an individual; and
generating a transaction request by using the transaction instruction and the user information, sending the transaction request to the server, and generating, by the server, transaction information corresponding to the product information according to the transaction request.

4. The product transaction information display method according to claim 3, wherein the user information comprises key information, the key information is generated through encryption by using metadata and block data, the metadata is a smallest data unit for transmission between the smart accessory and the client, the block data is a data set composed of a preset amount of metadata, and the key information comprises a key for personal identity authentication or digital currency payment.

5. The product transaction information display method according to claim 4, wherein the metadata comprises data content and definition information, the data content comprises specific data information, the definition information comprises metadata control information, a data encryption definition, and a personal privacy data definition, and byte content of the metadata control information is obtained by combining the data encryption definition with the personal privacy data definition.

6. The product transaction information display method according to claim 3, wherein the reading of the user information in the connected smart accessory according to the transaction instruction comprises:
reading block data in the connected smart accessory according to the transaction instruction;
identifying each piece of metadata in the block data, and obtaining a corresponding personal privacy data definition, an encoding and decoding mode, and data content according to a data structure of the metadata; and
decoding the data content according to the encoding and decoding mode, and extracting the corresponding user information from decoded data content according to the personal privacy data definition.

7. The product transaction information display method according to claim 6, wherein the block data is a data set composed of a preset amount of metadata, length information of the block data is placed in metadata control information, and when the block data is read in a storage medium of the smart accessory, each piece of metadata is identified according to an offset address in the block data, a corresponding decoding mode and data content are identified according to a data structure of the metadata, and the data content is decoded according to the decoding mode.

8. The product transaction information display method according to claim 3, wherein the user information is stored in the smart accessory worn by the individual, and the stored user information is used as a certificate of a distributed personal digital identity to implement decentralized authentication.

9. The product transaction information display method according to claim 3, wherein the user information comprises communication information and key information, and the method further comprises:
entering the extracted communication information into an order page accordingly to generate order information; and
generating a transaction request by using the order information, the key information, and the transaction instruction, and sending the transaction request to the server.

10. The product transaction information display method according to claim 9, further comprises:
after the server completes authentication on the transaction request according to the key information, receiving, by the client, payment information returned by the server; and
completing, by the server, payment corresponding to the transaction request by using digital currency according to the key information, and generating the corresponding payment information.

11. The product transaction information display method according to claim 2, wherein the connection region on the home page of the client comprises at least one connection button, and after the user identity is verified, the method further comprises:
when one connection button is triggered, generating a corresponding connection instruction, and establishing the communication connection to the to-be-connected smart accessory according to the connection instruction;
displaying a plurality of control buttons in the connection region after the communication connection is established; and
when one of the control buttons is triggered, generating a control setting instruction for the connected smart accessory, and accessing a corresponding control page according to the control setting instruction.

12. The product transaction information display method according to claim 1, wherein after the establishing of the communication connection between the client and the to-be-connected smart accessory according to the connection instruction, the method further comprises:
issuing, by the smart accessory, a connection status prompt comprising at least one of a sound prompt or a luminous prompt.

13. A transaction privacy protection system based on a smart accessory, comprising a terminal, the smart accessory, and a server, wherein
when there is a need to connect to the smart accessory or obtain product information, the terminal accesses a home page of a client, wherein the home page comprises a product information display region and a connection region for connecting to the smart accessory; the terminal pulls product information at the server, and displays at least one item of product information through the product information display region, wherein the product information comprises smart accessory product information; the terminal accesses an information page corresponding to the product information when obtaining a trigger instruction corresponding to the product information through the product information display region; and when obtaining a connection instruction corresponding to a to-be-connected smart accessory through the connection region, the terminal establishes a communication connection between the client and the to-be-connected smart accessory according to the connection instruction.

14. The transaction privacy protection system according to claim 13, wherein the terminal reads a user identity corresponding to the to-be-connected smart accessory according to the connection instruction, and when the user identity is verified, establishes the communication connection between the client and the to-be-connected smart accessory; and the terminal generates a product information obtaining request according to the user identity, and sends the product information obtaining request to the server through the client, such that the server returns personalized product information to the client.

15. The transaction privacy protection system according to claim 13, wherein the terminal obtains a transaction instruction corresponding to the product information through the product information display region, and reads user information in the connected smart accessory according to the transaction instruction, wherein the smart accessory is smart accessory worn by an individual; and the terminal generates a transaction request by using the transaction instruction and the user information, and sends the transaction request to the server, such that the server generates transaction information corresponding to the product information according to the transaction request.

16. The transaction privacy protection system according to claim 15, wherein the user information comprises key information, the key information is generated through encryption by using metadata and block data, the metadata is a smallest data unit for transmission between the smart accessory and the client, the block data is a data set composed of a preset amount of metadata, and the key information comprises a key for digital currency payment.

17. The transaction privacy protection system according to claim 15, wherein the terminal reads block data in the connected smart accessory according to the transaction instruction; identifies each piece of metadata in the block data, and obtains a corresponding personal privacy data definition, an encoding and decoding mode, and data content through parsing according to a data structure of the metadata; and decodes the data content according to the encoding and decoding mode, and extracts the corresponding user information from the parsed data content according to the personal privacy data definition.

18. The transaction privacy protection system according to claim 15, wherein the user information comprises communication information and key information, and the terminal enters the extracted communication information into an order page accordingly to generate order information; generates a transaction request by using the order information, the key information, and the transaction instruction, and sends the transaction request to the server; and the server completes authentication on the transaction request according to the key information, and the client receives payment information returned by the server.

19. The transaction privacy protection system according to claim 14, wherein the connection region on the home page of the client comprises at least one connection button, and after the user identity is verified, when one connection button is triggered, the terminal generates a corresponding connection instruction, and establishes the communication connection to the to-be-connected smart accessory according to the connection instruction; the terminal displays a plurality of control buttons in the connection region after establishing the communication connection; and when one of the control buttons is triggered, the terminal generates a control setting instruction for the connected smart accessory, and accesses a corresponding control page according to the control setting instruction.

20. The transaction privacy protection system according to claim 15, wherein the user information is stored in the smart accessory worn by the individual, and the stored user information is used as a certificate of a distributed personal digital identity to implement decentralized authentication.

21. A computer device, comprising a memory and one or more processors, wherein computer-readable instructions are stored in the memory, and when the computer-readable instructions are executed by the one or more processors, the one or more processors perform the following steps:
when there is a need to connect to a smart accessory or obtain product information, accessing a home page of a client, wherein the home page comprises a product information display region and a connection region for connecting to the smart accessory;
displaying at least one item of product information through the product information display region, wherein the product information comprises smart accessory product information;
accessing an information page corresponding to the product information when a trigger instruction corresponding to the product information is obtained through the product information display region; and
when a connection instruction corresponding to a to-be-connected smart accessory is obtained through the connection region, establishing a communication connection between the client and the to-be-connected smart accessory according to the connection instruction.

22. The computer device according to claim 21, wherein the computer device further performs the following steps:
obtaining a transaction instruction corresponding to the product information through the product information display region;
reading user information in the connected smart accessory according to the transaction instruction, wherein the smart accessory is a smart accessory worn by an individual; and
generating a transaction request by using the transaction instruction and the user information, and sending the transaction request to the server, such that the server generates transaction information corresponding to the product information according to the transaction request.

23. The computer device according to claim 22, wherein the user information comprises key information, the key information is generated through encryption by using metadata and block data, the metadata is a smallest data unit for transmission between the smart accessory and the client, the block data is a data set composed of a preset amount of metadata, and the key information comprises a key for personal identity authentication or digital currency payment.

24. The computer device according to claim 22, wherein the reading of the user information in the connected smart accessory according to the transaction instruction comprises:
reading block data in the connected smart accessory according to the transaction instruction;
identifying each piece of metadata in the block data, and obtaining a corresponding personal privacy data definition, an encoding and decoding mode, and data content according to a data structure of the metadata; and
decoding the data content according to the encoding and decoding mode, and extracting the corresponding user information from decoded data content according to the personal privacy data definition.

25. The computer device according to claim 22, wherein the user information comprises communication information and key information, and the computer device further performs the following steps:
entering the extracted communication information into an order page accordingly to generate order information;
generating a transaction request by using the order information, the key information, and the transaction instruction, and sending the transaction request to the server;
after the server completes authentication on the transaction request according to the key information, receiving, by the client, payment information returned by the server; and
completing, by the server, payment corresponding to the transaction request by using digital currency according to the key information, and generating the corresponding payment information.
